(19) United States
(12) Patent Application Publication
(10) Pub. No.: US 2007/0036262 A1
(43) Pub. Date: Feb. 15, 2007

(54) Autonomous, permanent comparative counting device which is intended for opinion polls

(76) Inventor: Robert Vitkine, Paris (FR)

Correspondence Address: YOUNG & THOMPSON, 745 SOUTH 23RD STREET, 2ND FLOOR, ARLINGTON, VA, 22202, US

(21) Appl. No.: 10/572,208

(22) PCT Filed: Nov. 4, 2003
(86) PCT No.: PCT/FR03/03282

§ 371 Date: Mar. 17, 2006

(30) Foreign Application Priority Data
Sep. 23, 2003 (FR) 03/11112

(51) Int. Cl. G06M 9/00

(52) U.S. Cl. 377/8

(57) ABSTRACT

An autonomously-powered counting device which can be used to collect, store and count several arrays on a single apparatus and perform a statistical comparative analysis under optimum neutrality conditions, includes a case which can permanently collect opinions without any human intervention with buttons connected to an array-counting and storage circuit. A time delay system is used to prevent votes from being repeated in rapid succession. The arrays are restored by consulting one or more counters or by remotely transmitting arrays via Hertzian waves, an optical link or a cable. The case (1) includes an integrated zone used to display the question posed to the polled users. The question posed may vary by command, by pre-defined programming, in a random manner, according to exogenous parameters or as a function of the response given to the previous question posed.

The present invention consists in a novel industrial product taking the form of a counting device for collecting, storing and counting several series on a single unit, enabling comparative analysis under optimum neutrality conditions.

Counters are usually intended to count isolated events independently of other events counted elsewhere.

The device of the invention overcomes this shortcoming and enables comparative counting in one and the same unit anywhere at any time.

At present there exist various voting machine systems or interactive terminal systems having the same functional purpose, but these systems are often complex, with sophisticated functions designed to prevent fraud. Such voting systems are usually activated or controlled by an operator, who authorizes and registers votes one by one.

The present invention proposes a solution that is simple to use, light in weight, compact and of esthetic appearance. What is more, the product operates autonomously and continuously.

More particular applications of the present invention include opinion polling providing a multiple choice without human intervention and thus without introducing the subjective bias of human researchers, whose presence influences those canvassed. The invention is intended to operate in places accessible to the public and in permanent mode, including at night and on public holidays.

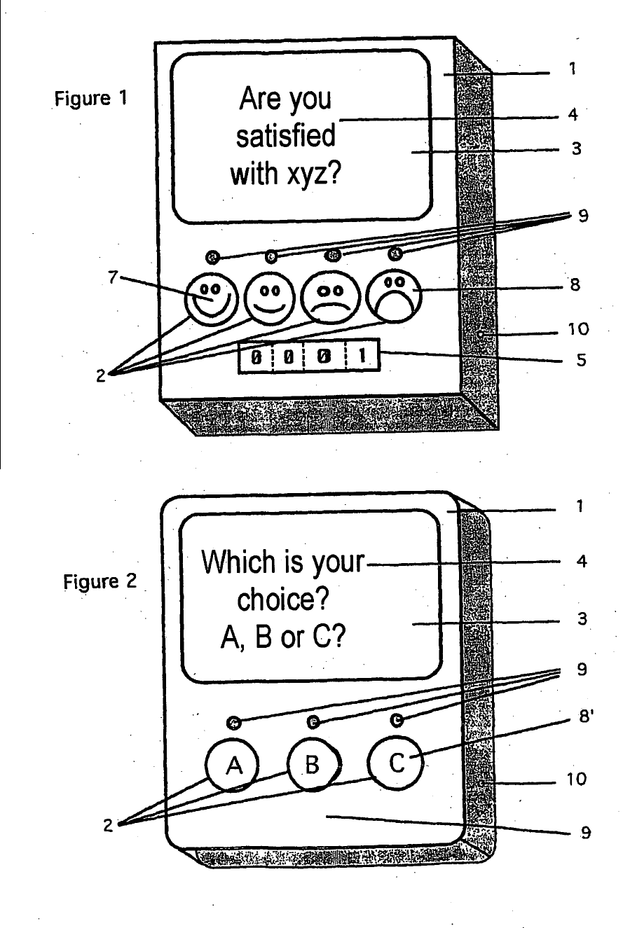

One embodiment is described by way of nonlimiting example with reference to the appended drawings, FIG. 1 and FIG. 2 whereof show a comparative counting device in a molded case (1):

FIG. 1 shows a product with an area (3) for displaying a question (4), four response buttons (2) and a counter (5) that is visible to the public.

FIG. 2 shows a product with an area (3) for displaying a question (4), three response buttons (2) and a counter that is concealed from the public (9).

More generally, the invention utilizes n means to count each element of n series with a minimum of two means and two series.

FIG. 1 shows the possibility of responding to a question by expressing a degree of satisfaction, with four possible responses corresponding to a scale from one to four.

The aforementioned means may take the form of buttons, handles or microphones with a voice control system. In the most widespread configuration there are from 2 to 10 buttons, without this upper figure being limiting on the invention.

As already indicated, FIG. 1 represents a configuration with four buttons (2).

The buttons are associated with a data type corresponding to expected responses, which can be digits, numbers, letters, words, names, colors, designs or pictograms.

FIG. 1 shows a configuration with four pictograms, illustrating the degree of support of the canvassed user on a scale running from strong support or high satisfaction, represented by a broad smile (7), to strong rejection or discontent, represented by an exaggerated grimace (8). The intermediate buttons are used to express intermediate opinions.

FIG. 2 shows a configuration with a series of three letters A-B-C (8′); the canvassed user is invited to choose one of the letters to express his choice.

The questions (4) shown in FIG. 1 and FIG. 2 have no particular significance and are intended only to illustrate this description.

To each button there corresponds a light-emitting diode (9) which blinks when the button is pressed to inform the canvassed user that his vote has been taken into account.

A time-delay prevents a canvassed user from easily expressing himself more than once, by way of “burst” voting. The time-delay is set according to the configuration of the site in which the device is installed and how busy it is.

The invention utilizes a device for storing series of responses. The device for storing series may be mechanical, analog or digital.

In the most widespread configuration, it is a dynamic memory included in an electronic circuit.

The link between the buttons and the counting and storage circuit may be effected via cables or by direct connection to the circuit.

A reset device (10) can be used to reset the counting memories.

The invention utilizes a device for output of the stored information.

The information may be collected directly in the device, in the form of counters, and consulted by authorized persons. A counter may be associated with each series or a single counter may be associated with all series. In this case, a device is used to read each of the series on the single counter in turn.

FIG. 1 shows a single counter (5) comprising four digits.

The counter(s) may be visible from the outside or hidden from voters. Hidden counters conceal the cumulative results of opinions already stored from canvassed users so as not to influence them.

Hidden series are displayed by pressing a concealed button at a location on the casing that is not readily accessible or a mechanical, magnetic or electronic key or by manipulating the visible buttons in accordance with a secret combination.

FIG. 1 shows a visible counter (5).

FIG. 2 shows a concealed counter (9), the digits of which become legible only after a maneuver is executed that is known only to persons responsible for collecting the polling results. In the illustration, the digits become luminous and are read through a covering area of the apparatus made from a translucent material.

In a variant, the series are communicated to a remote computer by radio, optical link or cable.

The casing (1) may be made of plastic, metal or any other material sufficiently strong for use in a public place by a large number of canvassed persons.

The electrical power supply of the system is provided by a battery or a rechargeable battery, optionally associated with photovoltaic cells; this renders the device autonomous. In variants consuming more energy, for example including voice recognition or remote transmission of series, the system is powered by the mains.

The casing incorporates an area (3) for displaying a question (4) put to canvassed users. The question is permanently visible to the public, who can express an opinion at any time, unlike the usual opinion polls, in which only solicited persons respond.

The text of the question may be printed directly on the casing or on a sticker stuck to the casing. The question is then changed by sticking on a new sticker.

Alternatively, the text of the question may be read on a built-in screen or a light-emitting display system. Electronic display enables changing of the questions by programming on site or by remote control.

The changes of question may also vary either in a programmed predefined order or at random. The formulation of the question put may also vary according to the time or exogenous parameters, for example the external temperature, how busy the site is, the ambient light level, the sound level or other parameters. Where applicable the change to the question and its formulation may also depend on the response given to the previous question. A change of question may be associated with a change of how the buttons or mechanisms are adapted to collect responses.

FIGS. 1 and 2 illustrate a configuration with a single printed question.

In a variant of the method, the opinion expressed by the last person may be revealed by pressing a concealed button at a place on the casing that is not readily accessible, using a mechanical, magnetic or electronic key, or by manipulating the visible buttons in accordance with a secret combination. This causes the diode corresponding to the button that the canvassed user has just pressed to blink, for example. This variant is useful with the pedagogical aim of improving the commercial approach, for example verifying that a sales argument is appropriate to the expectations of a prospective customer.

1. Device for comparative counting of alternative propositions for the purposes of opinion polling in autonomous and continuous mode, characterized in that it includes a casing (1) including two input means, generally buttons (2), for input of two series, supplied with power in autonomous mode by batteries, rechargeable batteries and/or photovoltaic cells, enabling collection in permanent mode of the choices of the public between two propositions, provided with an area (3) displaying the question (4) to which a response is requested, a digital or analog information storage device and a device (5) for displaying the series.

2. Device according to claim 1 characterized in that it includes more than two input means and series.

3. Device according to claim 1 characterized in that it further includes light-emitting diodes (9) associated with the buttons to indicate to a canvassed user that their opinion has been registered.

4. Device according to claim 1 characterized in that it further implements a time-delay between votes to prevent “burst” repetition of the choice expressed.

5. Device according to claim 1 characterized in that it conceals the display (9) of the series, which is rendered visible by means of a concealed button or key or by manipulation of the visible buttons in accordance with a secret combination.

6. Device according to claim 1 characterized in that it further includes transmission of the series by radio, optical link or cable.

7. Device according to claim 1 characterized in that it further enables the choice expressed by the last canvassed user to be determined using a concealed button or a key or by manipulating the visible buttons in accordance with a secret combination.

8. Device according to claim 1 characterized in that it includes a screen on which a question varies in a predefined or random order or according to the time or exogenous parameters or as a function of the response to the previous question.

9. Device according to claim 8 characterized in that it further includes variation of the modalities of responses in accordance with the variation of the questions.

10. Device according to claim 1 characterized in that it includes a mains power supply.
